(19) United States
(12) Patent Application Publication
(10) Pub. No.: US 2012/0162368 A1
(43) Pub. Date: Jun. 28, 2012

(54) IMAGE PROCESSING APPARATUS AND METHOD FOR PROCESSING IMAGE THEREOF

(75) Inventor: Jong-chul CHOI, Suwon-si (KR)

(73) Assignee: Samsung Electronics Co., Ltd.

(21) Appl. No.: 13/337,711

(22) Filed: Dec. 27, 2011

(30) Foreign Application Priority Data
Dec. 27, 2010 (KR) 10-2010-0135808

(51) Int. Cl. H04N 13/00

(52) U.S. Cl. 348/45; 348/E13.074

(57) ABSTRACT

An image processing apparatus is provided. The image processing apparatus includes a photographing unit which photographs a plurality of images of biological tissue within a living body, an extracting unit which extracts at least two images with relatively higher relevancy from among the plurality of photographed images, and a control unit which calculates depth information based on the at least two extracted images, and generates a three dimensional (3D) image of the biological tissue using the calculated depth information.

### PRIORITY

This application claims priority under 35 U.S.C. 119(a) to a Korean Patent Application No. 10-2010-0135808, filed on Dec. 27, 2010 in the Korean Intellectual Property Office, the contents of which are incorporated herein by reference.

### BACKGROUND OF THE INVENTION

1. Field of the Invention

The present invention relates generally to processing an image, and more particularly, to an image processing apparatus to detect a lesion, and a method for processing an image thereof.

2. Description of the Related Art

The recent developments in the medical engineering field have been accompanied by active studies on image processing apparatuses such as endoscopes.

Conventionally, a practitioner observes a lesion by injecting air into a site at which the lesion is possible and determining whether the site inflates, or by directly injecting a drug into a potential lesion area and determining whether the area inflates.

Another conventional method is to spray colorant onto a potential site using an endoscope, or irradiate light with a specific wavelength to the potential site to determine whether a lesion is present thereon.

The above conventional methods, however, cannot provide a precise way to check the lesion. Accordingly, a method is necessary, by which a practitioner is able to check and detect the lesion with improved accuracy using an endoscope.

### SUMMARY OF THE INVENTION

The present invention is disclosed to overcome the above disadvantages and other disadvantages not described above.

According to the present invention, an image processing apparatus and a method for processing an image thereof are provided, which are capable of processing so that a lesion site is displayed as a three dimensional (3D) image.

A method for processing an image of an image processing apparatus includes photographing a plurality of images of biological tissue within a living body, extracting at least two images having a high correlation to each other among the plurality of photographed images, calculating depth information based on the at least two extracted images, and generating a 3D image of the biological tissue using the calculated depth information.

An image processing apparatus is provided, including a photographing unit which photographs a plurality of images of biological tissue within a living body, an extracting unit which extracts at least two images having a high correlation to each other among the plurality of photographed images, and a control unit which calculates depth information based on the at least two extracted images, and generates a 3D image of the biological tissue using the calculated depth information.

### BRIEF DESCRIPTION OF THE DRAWINGS

The above and/or other aspects of what is described herein will be more apparent by describing embodiments with reference to the accompanying drawings, in which:

FIG. 1 illustrates an image processing apparatus according to the present invention;

FIG. 2 illustrates a distal tip of the image processing apparatus according to the present invention;

FIGS. 3A and 3B illustrate an image photographing operation of the image processing apparatus according to the present invention;

FIG. 4 illustrates an operation of compensating for a movement of the distal tip when the distal tip is shifted by a driving control unit, according to the present invention;

FIG. 5 illustrates a concept of disparity related to depth information, according to the present invention;

FIG. 6 illustrates a rotation compensation processing that may be concurrently conducted during a shifting operation between rotating operation and shifting operation of the distal tip, according to the present invention;

FIG. 7 illustrates the rotating operation of the distal tip, according to the present invention;

FIGS. 8 and 9 illustrate a disparity according to a distance to object, according to a first embodiment of the present invention;

FIG. 10 illustrates various values according to distances to object of FIGS. 7 to 9;

FIG. 11 illustrates a disparity according to a distance to object, according to a second embodiment of the present invention;

FIG. 12 illustrates various values according to distances to object of FIGS. 7, 8 and 11; and

FIG. 13 illustrates a method for processing an image of an image processing apparatus, according to the present invention.

### DETAILED DESCRIPTION OF EMBODIMENTS OF THE INVENTION

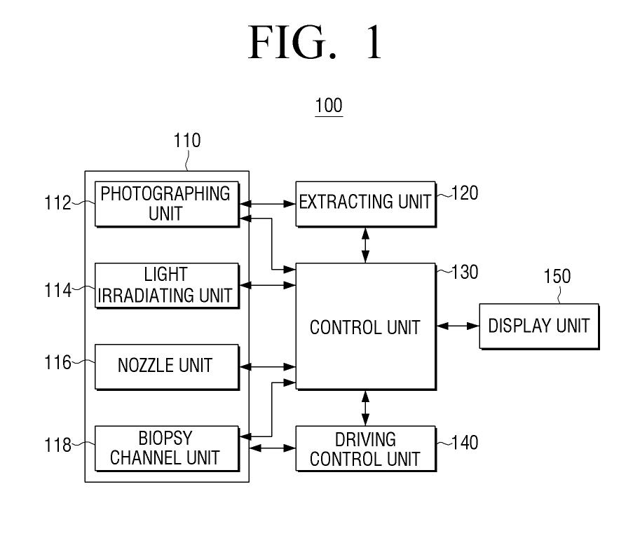

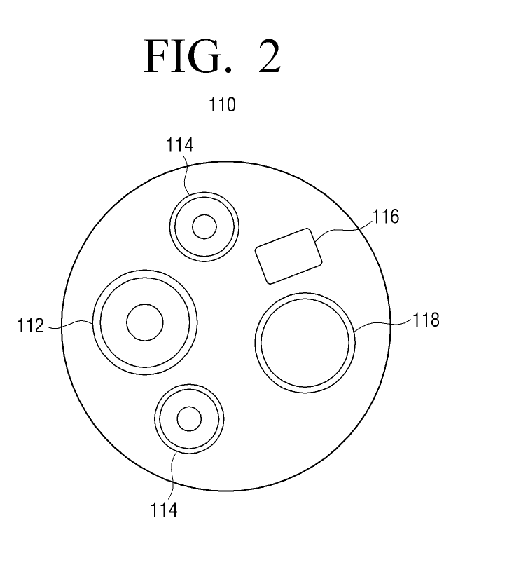

Embodiments of the present invention will be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. Throughout the drawings, the same drawing reference numerals will be understood to refer to the same elements, features and structures. In addition, descriptions of well-known functions and constructions are omitted for the sake of clarity and conciseness. FIG. 1 illustrates an image processing apparatus according to the present invention, and FIG. 2 illustrates a distal tip of the image processing apparatus according to the present invention.

Referring to FIG. 1, an image processing apparatus 100 includes a distal tip (or distal end) 110, an extract unit 120, a control unit 130, a driving control unit 140 and a display unit 150. Among these constituents, the distal tip 110 and the driving control unit 140 may constitute an endoscope.

Referring to FIG. 2, the distal tip 110 includes a photographing unit 112, a light irradiating unit 114, a nozzle unit 116 and a biopsy channel unit 118.

The distal tip 110 may be arranged on a front end (i.e., one end adjacent to a living organism) to be inserted into a body cavity of a living body. Since the distal tip 110 is inserted into a living body, the distal tip 110 may be coated by a coating layer that is treated with a toxicity treatment, or the like, for biocompatibility purposes.

The photographing unit 112 may photograph various objects within the body such as, for example, biological tissue or a lesion. The photographing unit 112 includes at least one camera lens (not illustrated).

The light irradiating unit 114 irradiates light onto various objects within the living body. Based on the light irradiation of the light irradiating unit 114, biological tissue such as a lesion within the body, is photographed with ease.

The nozzle unit 116 includes at least one nozzle (not illustrated). Specifically, the nozzle unit 116 includes at least one of a nozzle to inject water into biological tissue within the living body, and a nozzle to inject air into the biological tissue.

The biopsy channel unit 118 extracts biological tissue from the living body. For example, the biopsy channel unit 118 may have a hollow structure.

The distal tip 110 additionally includes at least one of a frame unit (not illustrated) to support the constituents 112, 114, 116, 118 and a cladding unit (not illustrated) wrapped on the frame unit (not illustrated).

However, the constituents 112, 114, 116, 118 of the distal tip 110 as illustrated in FIG. 2 are only an example, and the construction of the distal tip 110 is not limited to a specific number, shape or pattern of arrangement of parts.

The extracting unit 120 extracts at least two images having a high correlation to each other among a plurality of images photographed at the photographing unit 112. The ‘high correlation’ herein refers to a degree of similarity with the other images so that the images having a high correlation to each other are more similar to each other.

The extracting unit 120 extracts images having a high correlation to each other using a specific shape or pattern of the photographed images. For example, if a first photographed image includes two lesions therein, a second photographed image having a high correlation to each other in terms of locations, sizes and shapes of the two lesions may be extracted from among the other photographed images. Alternatively, instead of one image that has the highest relevancy to the first image, two images having a high correlation to each other compared to the first image may be extracted, and the number of extracted images may vary as design is modified.

The control unit 130 performs the overall control operation on the constituents 110, 120, 140, 150 of the image processing apparatus 100.

Further, the control unit 130 performs various image processing, such as calculating depth information from the at least two extracted images and generating a 3D image with respect to the biological tissue based on the calculated depth information.

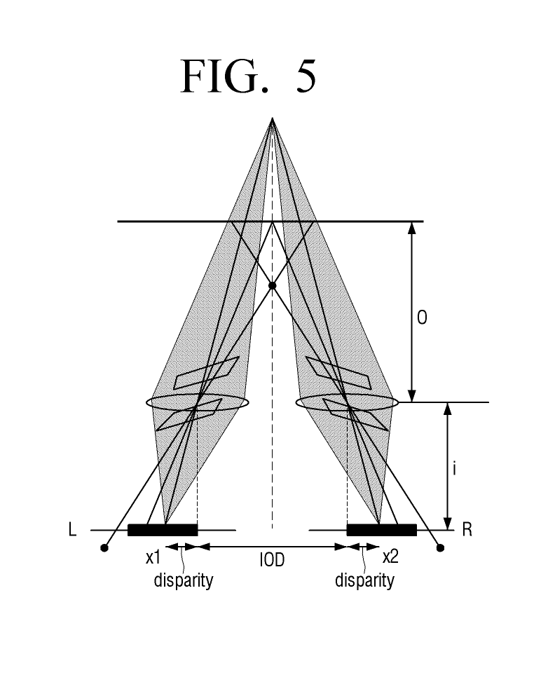

For example, if the first and second images having the highest correlation to each other are extracted at the extracting unit 120, there may occur disparity between the first and second images. Accordingly, depth information may be calculated from the first and second images. The depth information may be, for example, the disparity, which will be explained below with respect to FIG. 5.

Accordingly, the control unit 130 generates a 3D image with respect to the biological tissue based on the calculated depth information from the first and second images, analyzes the plurality of photographed images, and generates a map image representing the entirety of a specific living organism, using the plurality of photographed images. The map image generated at the control unit 130 may be stored to a storage unit (not illustrated) as an image file.

Further, the control unit 130 may perform compensation processing which will be explained below.

The driving control unit 140 controls the driving operation of the distal tip 110. Specifically, the driving control unit 140 may cause the photographing unit 112 attached to an area of the distal tip 110 to rotate or shift by moving the distal tip 110, and also control the photographing unit 112 to photograph an image. The driving control unit 140 directly controls the photographing unit 112 to rotate or shift, and controls the light irradiating unit 114 to irradiate light onto biological tissue. The driving control unit 140 also controls the nozzle unit 116 to inject water or air, controls the biopsy channel unit 118 to take a surface of a living organism, if the biopsy channel unit 118 does not have a hollow structure, e.g., if the biopsy channel unit 118 includes a tool for extracting the surface of the living organism and a microstructure storing the surface extracted from the living organism.

The display unit 150 displays the generated 3D image.

If the control unit 130 analyzes the plurality of photographed images, the display unit 150 may display a 3D image of an image that has the lesion larger than a preset size from among the photographed images. The preset size may be stored in advance, or varied by a user.

The display unit 150 displays the image including a lesion larger than the preset size in different colors to distinguish the image from the ambient biological tissue.

If the control unit 130 generates a map image with respect to the entirety of a specific biological tissue using the plurality of photographed images, the display unit 150 displays the generated map image.

Meanwhile, the image processing apparatus 100 additionally includes a storage unit (not illustrated), which stores an image of biological tissue, or a map image of an entirety of specific biological tissue such as the stomach or duodenum. Along with the image or map image, the storage unit (not illustrated) may store reference coordinate values, and coordinate values and direction values to represent a location of the biological tissue, along with information indicative of the time at which the image is photographed. The additional information other than the images stored in the storage unit (not illustrated) may be used at the extracting unit 120 to calculate images with relatively higher relevancy.

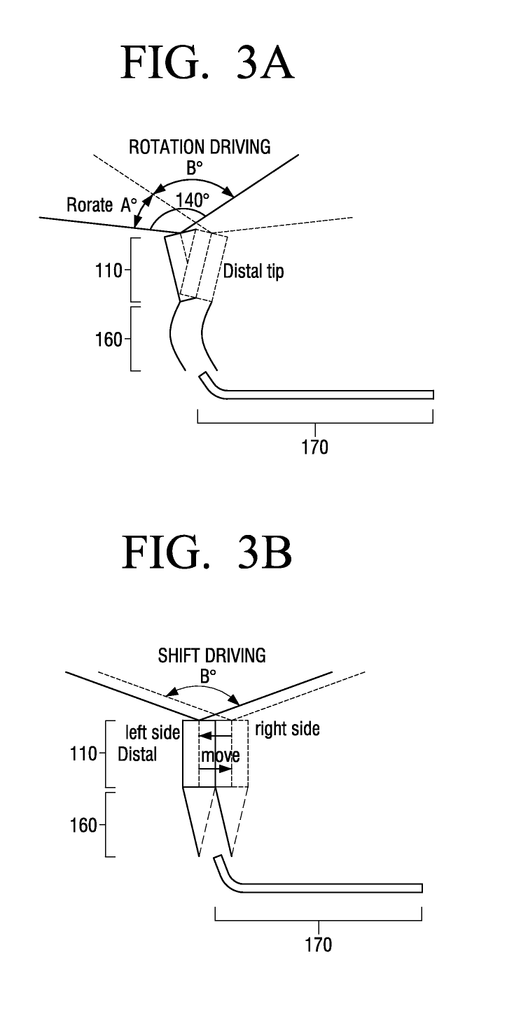

FIGS. 3A and 3B illustrate an image photographing operation of the image processing apparatus according to the present invention.

Referring to FIGS. 3A and 3B, the image processing apparatus 100 additionally includes a bendable portion 160 and a wire portion 170.

The bendable portion 160 is connected to the wire portion 110, and controls rotation driving operation or shift driving operation of the wire portion 110. The wire portion 170 is connected to the bendable portion 160 and provides the driving control operation of the driving control unit 140 to the distal tip 110 through the bendable portion 160. As a result, the bendable portion 160 moves in accordance with the driving control operation of the driving control unit 140, and concurrently, the distal tip 110 rotates or shifts.

Referring to FIG. 3A, the distal tip 110 may rotate to an angle of A°. Accordingly, a Field Of View (FOV) at which the biological tissue is photographed through the photographing unit 112 of the distal tip 110 may be B°. The photographing unit 112 may photograph a plurality of images while the distal tip 110 rotates by A°.

Referring to FIG. 3B, the distal tip 110 may move to a right side and left side as illustrated, and according to such movement, the FOV of the distal tip 110 may be B°. The photographing unit 112 may photograph a plurality of images while the distal tip 110 moves to the right direction, as illustrated.

When the distal tip 110 rotates or shifts, the photographing unit 112 provided on an area of the distal tip 110 photographs images of biological tissue, such as a lesion.

Referring to FIGS. 1, 3A and 3B, among the constituents of the image processing apparatus 100, the distal tip 110, the bendable portion 160, the wire portion 170 and the driving control unit 140 constitute an endoscope. The extracting unit 120, the control unit 130 and the display unit 150 constitute a separate device. Alternatively, the distal tip 110, the wire portion 160, the wire portion 170, and the driving control unit 140, along with the extracting unit 120 and the control unit 130 may constitute an endoscope.

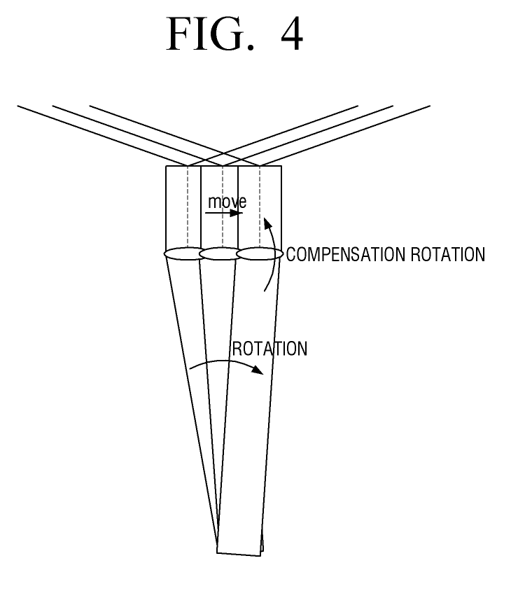

FIG. 4 illustrates an operation to compensate for a movement of the distal tip when the driving control unit shifts the distal tip, according to the present invention.

Referring to FIG. 4, if the driving control unit 140 moves the distal tip 110 to the right side as illustrated, according to a movement control of the driving control unit 140, only a lower portion of the bendable portion 160 can be moved to the right side. As a result, an upper portion of the bendable portion 160, which is connected to the distal tip 110, may not move to the right side or may move to the right side but to a lesser degree than the lower portion. Accordingly, compensation processing is desirably carried out to rotate the upper portion of the bendable portion 160 connected to the distal tip 110 to the right direction.

For the purpose of compensation processing, a rotation compensating means such as a gear or motor (not illustrated) may be provided to a boundary between the distal tip 110 and the bendable portion 160.

FIG. 5 illustrates a concept of disparity related to the depth information, according to the present invention.

Referring to FIG. 5, disparity, i.e., a distance difference, occurs as an object is seen from two difference directions. The disparity may be depth information.

If one object is seen, disparity may be calculated by the following Equation (1):

$$disparity = \frac{ixIOD}{O} \qquad ( 1 )$$

where, i refers to a distance between a sensor and a lens, IOD is a horizontal distance between centers of a left lens and a right lens, and O is a distance between a lens and an object.

The disparity (Δdisparity) may be calculated by the following Equation (2) if two objects are seen:

$$Δ disparity = ixIODx ( \frac{1}{{O}_{n}} - \frac{1}{{O}_{f}} ) \qquad ( 2 )$$

where, i refers to a distance between a sensor and a lens, IOD is a horizontal distance between centers of a left lens and a right lens, Oₙ is a distance between a lens and an object at a nearer distance, and O_{f} is a distance between a lens and an object at a farther distance.

In the above example, the sensor may be arranged at a location corresponding to the eyes of a human, and implemented as a Charge Coupled Device (CCD) or Complementary Metal-Oxide Semiconductor (CMOS) image sensor that includes a plurality of pixels.

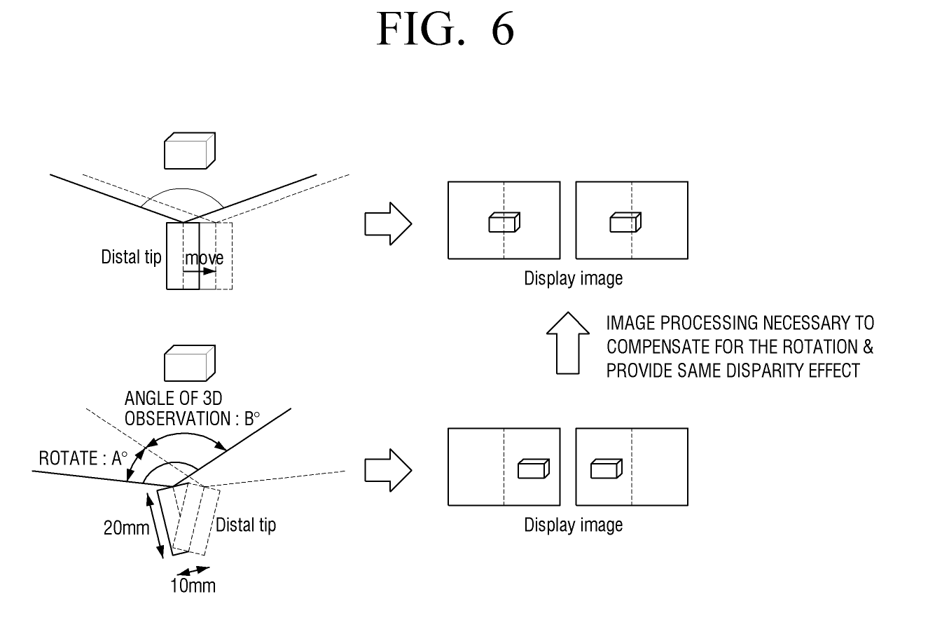

FIG. 6 illustrates the rotation compensation processing which may be carried out concurrently during a shifting operation between rotation and shifting operations of the distal tip, according to the present invention.

Referring to the upper-half of FIG. 6, an object appears to have moved to the left direction in the image when the distal tip 110 is shifted to the right direction. Referring to the lower-half of FIG. 6, the object appears to have moved to the left direction when the distal tip 110 is rotated in a clockwise direction.

Herein, compared to when the distal tip 110 is shifted, the object appears to have been moved farther than the object was actually moved if the distal tip 110 is rotated. Accordingly, if the distal tip 110 is rotated, a compensation processing is performed to obtain a result as if the distal tip 110 is moved to a degree less than when the distal tip 110 is shifted.

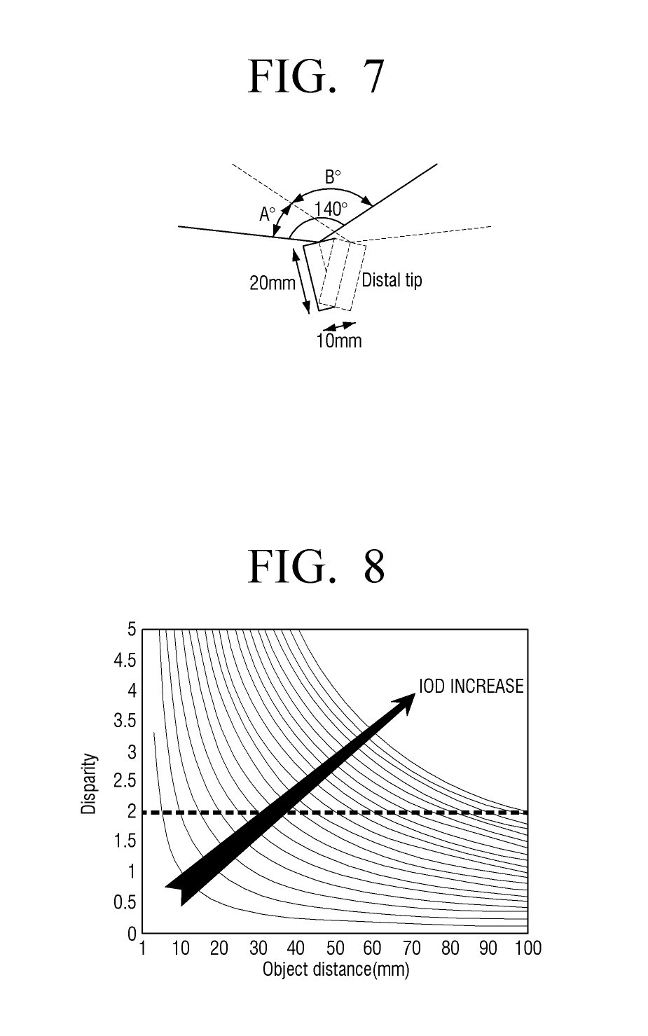

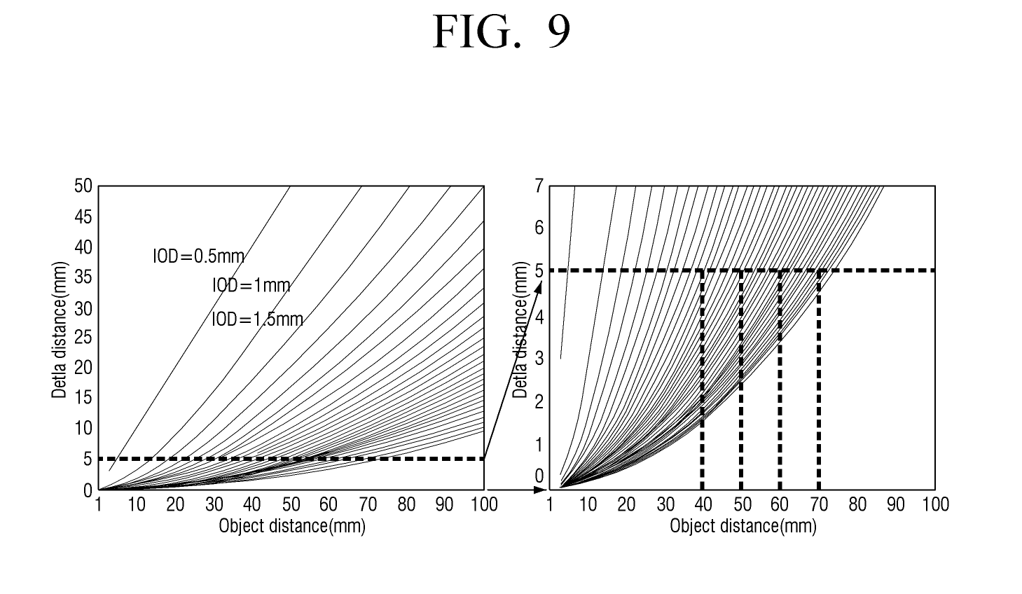

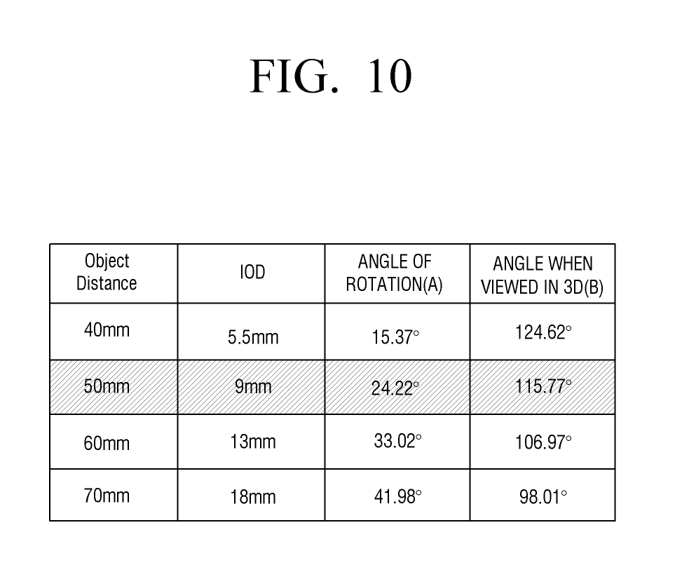

FIG. 7 illustrates a rotation operation of the distal tip, according to the present invention, and FIGS. 8 and 9 illustrate a disparity according to distances to an object, and FIG. 10 illustrates various values according to the distances to the object of FIGS. 7 to 9.

Referring to FIGS. 7 to 10, in a first embodiment, a 5 mm protrusion (object) is detected under a condition that the lens focal distance of the photographing unit 112 is 0.5 mm, and the pixel pitch of the sensor is 3.3 μm, 3×3 pixels.

Referring to FIG. 8, if the distal tip 110 of FIGS. 1-3 is rotated and the distances to object are same, the disparity increases as IOD increases. Referring to FIG. 9, if distances to the objects are the same and the distal tip 110 is rotated, a disparity between two objects decreases as IOD increases. Referring to FIG. 10, it is also confirmed that the IOD is 9 mm when a distance to object is 50 mm.

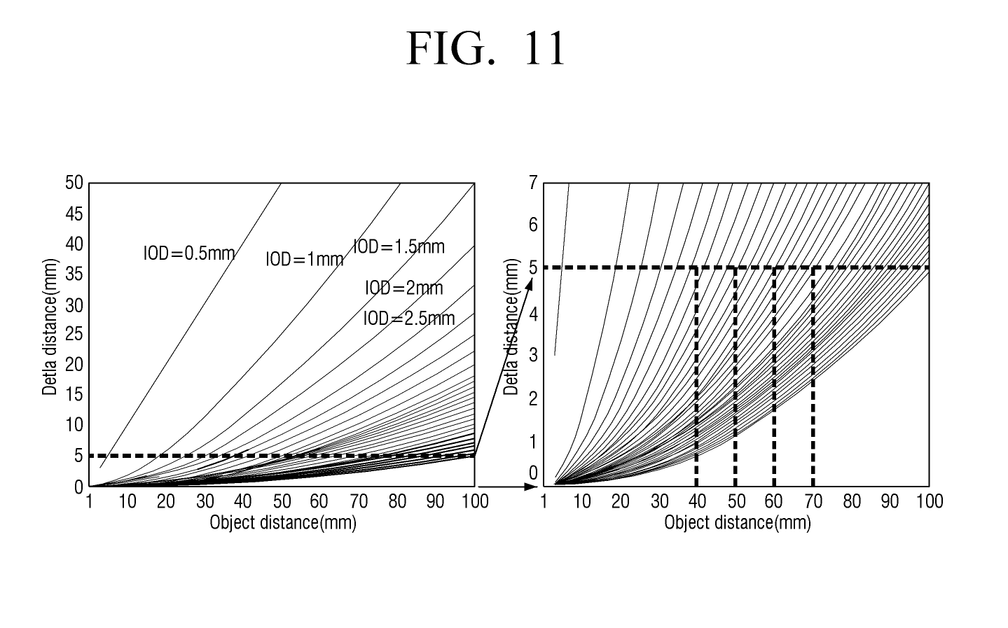

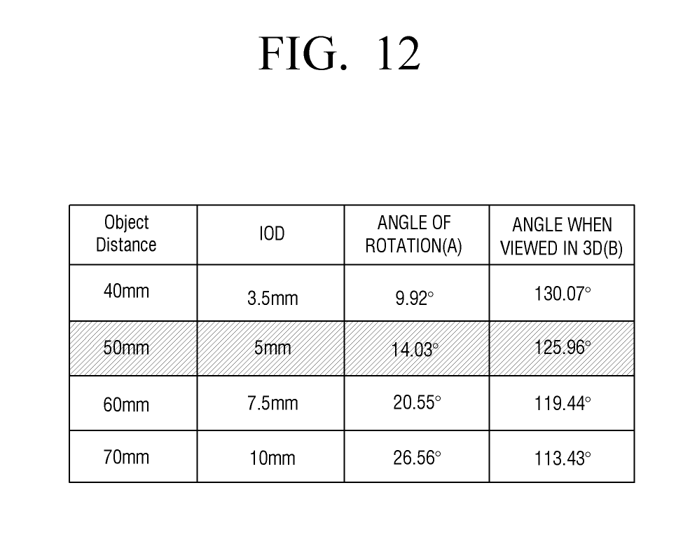

FIG. 11 illustrates a disparity according to a distance to an object, according to the present invention, and FIG. 12 illustrates various values according to the distances to the object of FIGS. 7, 8 and 11.

Referring to FIGS. 7, 8, 11, and 12, in a second embodiment, 5 mm protrusion (object) is detected under a condition that the lens focal distance of the photographing unit 112 is 0.5 mm, and the pixel pitch of the sensor is 1.7 μm, 3×3 pixels.

Referring to FIG. 8, if distances to object are identical and the distal tip 110 is rotated, disparity increases as IOD increases. Referring to FIG. 11, if distances to object are identical and the distal tip 110 is rotated, disparity between two objects decreases as IOD increases. Referring to FIG. 12, IOD is 5 mm when a distance to object is 50 mm.

In comparing the first and second embodiments, in an assumption that the distances to object are identical, the second embodiment has a smaller IOD than the first embodiment, which accordingly indicates that resolution increases since IOD decreases as the pixel pitch of the sensor deceases under the same condition.

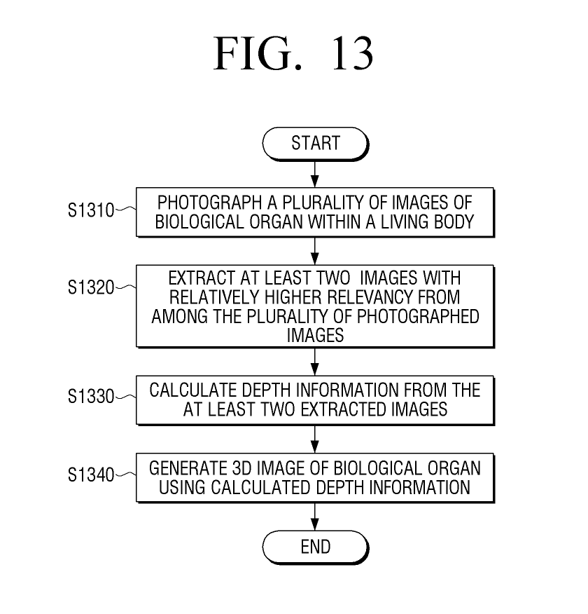

FIG. 13 illustrates a method for processing an image of an image processing apparatus, according to the present invention.

Referring to FIG. 13, at step S1310, the photographing unit 112 photographs a plurality of images of biological tissue within a body.

At step S1320, the extracting unit 120 extracts at least two images with relatively higher relevancy from among the plurality of photographing images. Specifically, the at least two images have a higher relevancy than the remaining plurality of photographing images.

At step S1330, the control unit 130 calculates depth information from the at least two extracted images.

At step S1340, the control unit 130 then generates a 3D image with respect to the biological tissue using the calculated depth information.

The foregoing embodiments and advantages are not to be construed as limiting the present inventive concept. The present teaching can be readily applied to other methods and types of apparatuses. Also, the description of the present invention is intended to be illustrative, and not to limit the scope of the claims, and many alternatives, modifications, and variations will be apparent to those skilled in the art.

What is claimed is:

1. A method for processing an image of an image processing apparatus, the method comprising:
photographing a plurality of images of biological tissue within a living body;
extracting at least two images having a high correlation to each other among the plurality of photographed images;
calculating depth information based on the at least two extracted images; and
generating a three dimensional (3D) image of the biological tissue using the calculated depth information.

2. The method of claim 1, wherein photographing the plurality of images comprises photographing the plurality of images according to a rotating or shifting operation of a distal tip of the image processing apparatus.

3. The method of claim 1, further comprising displaying the generated 3D image.

4. The method of claim 3, further comprising analyzing the plurality of photographed images, wherein displaying the generated 3D image comprises displaying an image including a larger lesion than a preset size as a 3D image from among the plurality of photographed images.

5. The method of claim 3, further comprising generating a map image of the biological tissue using the plurality of photographed images, wherein the displaying comprises displaying the map image.

6. The method of claim 1, wherein the image processing apparatus comprises an endoscope.

7. An image processing apparatus, comprising:
a photographing unit which photographs a plurality of images of biological tissue within a living body;
an extracting unit which extracts at least two images having a high correlation to each other among the plurality of photographed images; and
a control unit which calculates depth information based on the at least two extracted images, and generates a three dimensional (3D) image of the biological tissue using the calculated depth information.

8. The image processing apparatus of claim 7, further comprising a driving control unit which controls an operation of the photographing unit, wherein the photographing unit photographs the plurality of images according to a rotating or shifting operation performed under the control of the driving control unit.

9. The image processing apparatus of claim 7, further comprising a display unit that displays the generated 3D image.

10. The image processing apparatus of claim 9, wherein the control unit analyzes the plurality of photographed images, and the display unit displays an image including a larger lesion than a preset size as a 3D image from among the plurality of photographed images.

11. The image processing apparatus of claim 9, wherein the control unit generates a map image of the biological tissue using the plurality of photographed images, and the display unit displays the map image.

12. The image processing apparatus of claim 7, wherein the image processing apparatus comprises an endoscope.
